(19) United States
(12) Patent Application Publication
(10) Pub. No.: US 2003/0057700 A1
(43) Pub. Date: Mar. 27, 2003

(54) Connector fitting structure

(75) Inventor: Tomomi Endo, Shizuoka (JP)

Correspondence Address: SUGHRUE MION, PLLC, 2100 PENNSYLVANIA AVENUE, N.W., WASHINGTON, DC, 20037, US

(73) Assignee: YAZAKI CORPORATION

(21) Appl. No.: 10/155,982

(22) Filed: May 29, 2002

(30) Foreign Application Priority Data
May 31, 2001 (JP) P2001-164840

(51) Int. Cl. F16L 37/00

(52) U.S. Cl. 285/305

(57) ABSTRACT

In a connector fitting structure of the invention, when a female connector housing (40), having a female terminal (41) received in a terminal receiving chamber (44), is fitted on a male connector housing (30) having a male terminal (33) projecting into a fitting chamber (32), the female terminal (41) and the, male terminal (33) are connected together. The male connector housing (30) includes a narrowed portion (35) of such a length that the narrowed portion extends beyond a distal end of the male terminal (33) in a fitting direction, and during the fitting of the male and female connector housings (30,40) to each other, the narrowed portion (35) abuts against a front end of the female connector housing (40) before insertion of the male terminal (33) into the female connector housing (40), thereby regulating the fitting angle of the female connector housing (40) to a proper fitting direction.

The present application is based on Japanese Patent Application No. 2001-164840, which is incorporated herein by reference.

### BACKGROUND OF THE INVENTION

1. Field of the Invention

This invention relates to a connector fitting structure in which when fitting a pair of male and female connector housings (one of which has a narrowed portion) together, the angle of fitting of the second connector housing is regulated to a proper fitting direction by the narrowed portion.

2. Description of the Related Art

In a conventional connector fitting structure shown in FIGS. 5 and 6, when a male connector housing 1, having a male terminal 4 projecting into a fitting chamber 3, is fitted into a female connector housing 10, having a female terminal 11 received in a terminal receiving chamber 15, the male terminal 4 and the female terminal 11 are connected together. This fitting structure will be described briefly.

As shown in FIG. 5, the male connector housing 1 has a substantially tubular shape, and includes a tubular wall portion 2 of an integrally-molded construction, and the fitting chamber 3 for receiving the female connector housing 10 is defined by an inner peripheral surface of the wall portion 2. The male connector housing 1 has the male terminal 4 projecting into the fitting chamber 3, and an engagement groove 7 is formed on an outer surface of the wall portion 2 along the fitting direction. A retaining portion 5 which holds the male connector housing in a fitted condition to the female connector housing 10 is formed in the engagement groove 7. A narrowed portion 6 for regulating the direction of connection of the female terminal 11 to the male terminal 4 is formed at an inner end portion of the fitting chamber 3, and this narrowed portion 6 has such a length in the fitting direction that its front end substantially coincides with the distal end of the projecting male terminal 4.

The female connector housing 10 includes a fitting portion 12, provided at a center portion thereof, and a flexible lock arm 4 having at its front end an engagement projection 13 for engagement with the retaining portion 5 of the male connector housing 1, and this flexible lock arm slides along the engagement groove 7 in the male connector housing 1 during the fitting operation. The terminal receiving chamber 15, in which the female terminal 11 is received, is formed within the fitting portion 12, and the fitting portion 12 has an insertion hole 12a formed in a front end thereof, and the male terminal 4 is inserted into the terminal receiving chamber through this insertion hole.

A fitting detection member 16 for detecting a half-fitted condition of the male and female connector housings 1 and 10 is fitted on the female connector housing 10, and substantially covers this female connector housing.

When fitting the male and female connector housings 1 and 10 together, the flexible lock arm 14 slides along the engagement groove 7 in the male connector housing 7, thereby substantially properly regulating the fitting direction. At this time, the fitting portion 12 of the female connector housing 10 is fitted into the fitting chamber 3 in the male connector housing 1. Then, the front end of the fitting portion 12 reaches the front end of the narrowed portion 6, and thereafter the front end of the fitting portion 12 is brought into abutting engagement with the front end of the narrowed portion 6 or an inner surface near the front end of the narrowed portion 6 disposed near to the front end thereof, thereby regulating the fitting angle to the proper fitting direction.

When the female connector housing 10 is further inserted in the fitting direction after the fitting direction is regulated, the flexible lock arm 14 slides over the retaining portion 5, and is engaged therewith, and the male terminal 4 is inserted into the terminal receiving chamber 15 in the female connector housing 10 through the insertion hole 12a, and is electrically connected to the female terminal 11, so that the male and female connector housings 1 and 10 are completely fitted together. At the time of achieving the completely-fitted condition, the fitting detection member 16 is pushed to be moved in the fitting direction, and is retained in a properly-fitting detection position, so that the completely-fitted condition of the male and female connector housings 1 and 10 can be detected (see FIG. 6).

The proper fitting operation of the conventional connector has been described above, and the flexible lock arm 14 on the female connector housing 10 slides along the engagement groove 7 in the male connector housing 1, thereby substantially properly regulating the fitting direction. However, if the female connector housing 10 is fitted on the male connector housing 1, for example, in inclined relation to the axis of fitting of the male connector housing 1 when the front end of the fitting portion 12 reaches the front end of the narrowed portion 6 of the male connector housing 1 as shown in FIG. 7, there is encountered a problem that the front end of the fitting portion 12 of the female connector housing 10 impinges on the distal end of the male terminal 4 in the male connector housing 1 to bend this male terminal or in some cases to damage it.

### SUMMARY OF THE INVENTION

This invention has been made in view of the above problem, and an object of the invention is to provide a connector fitting structure in which when fitting a pair of male and female connector housings together, the fitting angle of one of the two connector housings is regulated to a proper fitting direction before the first connector housing receives a male terminal.

The above problem to be dealt with by the present invention, has been solved by a connector fitting structure comprising: a first connector housing including a female terminal received in a terminal receiving chamber; a second connector housing including a male terminal projecting into a fitting chamber and a narrowed portion having such a length that the narrowed portion extends beyond a distal end of the male terminal in a fitting direction; wherein the narrowed portion abuts against a front end of the first connector housing before the male terminal is fittingly inserted into the first connector housing, so that a fitting angle of the first connector housing is regulated to a proper fitting direction, and wherein the female terminal and the male terminal are connected together when the first connector housing is fitted to the second connector housing.

In the connector fitting structure of the above construction, the second connector housing includes the narrowed portion of such a length that the narrowed portion extends beyond the distal end of the male terminal in the fitting direction.

Therefore, during the fitting of the two connector housings to each other, the narrowed portion abuts against the front end of the first connector housing before the insertion of the male terminal into the first connector housing, thereby regulating the fitting angle of the first connector housing to the proper fitting direction, and therefore the front end of the first connector housing is prevented from impinging on the distal end of the male terminal.

### BRIEF DESCRIPTION OF THE DRAWINGS

FIG. 1 is a perspective view showing a male connector housing of one preferred embodiment of a connector fitting structure of the invention;

FIG. 2 is a vertical cross-sectional view of the male connector housing of FIG. 1;

FIG. 3 is a vertical cross-sectional view, showing a condition in which a fitting portion of a female connector housing is inserted into such a position that its distal end is disposed at a front end of a narrowed portion of the male connector housing;

FIG. 4 is a vertical cross-sectional view showing a condition in which the fitting portion of the female connector housing is just to receive a male terminal;

FIG. 5 is a vertical cross-sectional view of a conventional connector fitting structure, showing a condition before a fitting operation is effected;

FIG. 6 is a vertical cross-sectional view showing a condition in which the fitting of male and female connector housings of FIG. 5 is completed, and the sliding movement of a fitting detection member into a proper fitting detection position is completed; and

FIG. 7 is a vertical cross-sectional view showing a condition in which the female connector housing of FIG. 5 is fitted on the male connector housing in inclined relation to the fitting axis of the male connector housing.

### DETAILED DESCRIPTION OF THE PREFERRED EMBODIMENTS

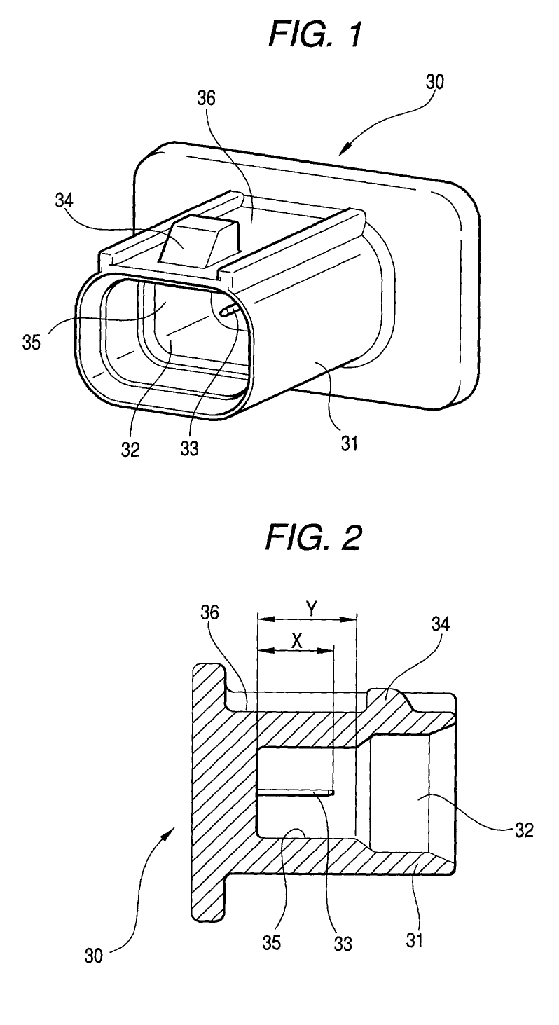

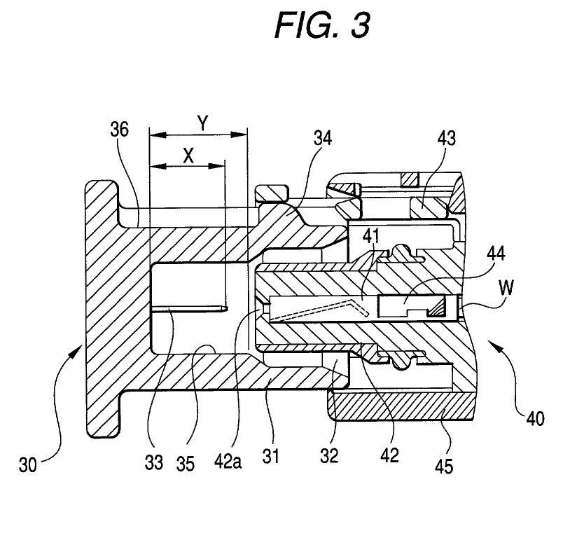

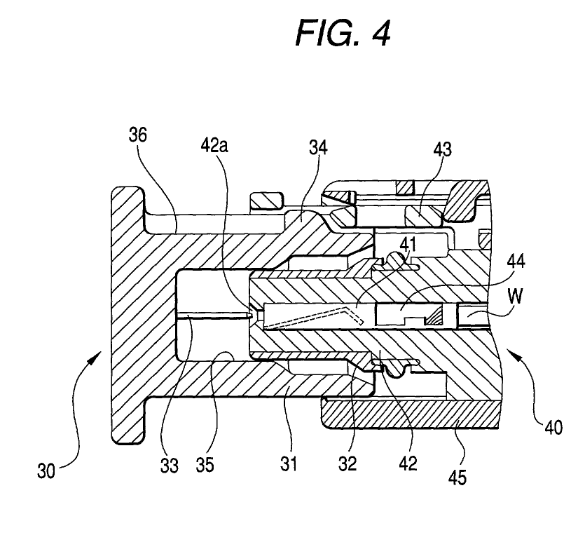

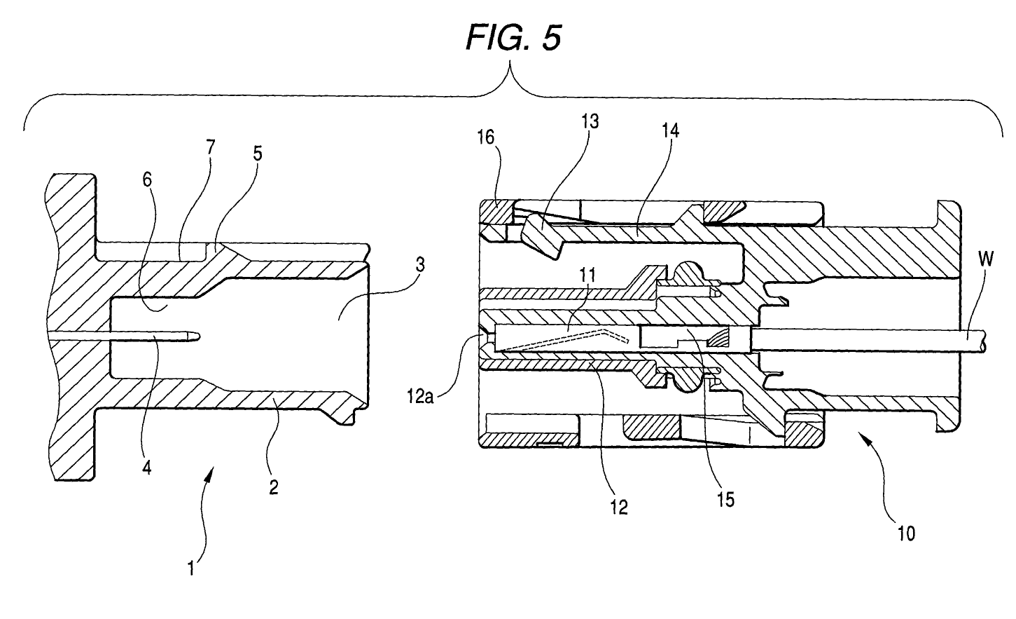

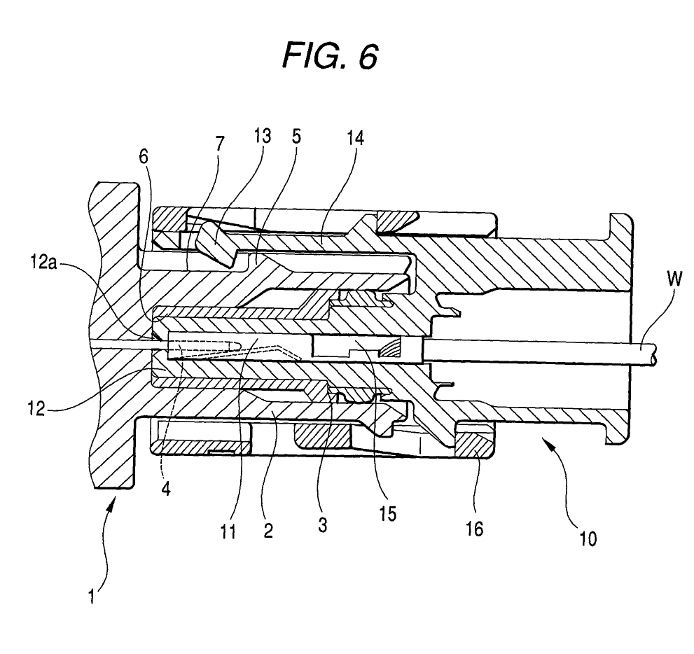

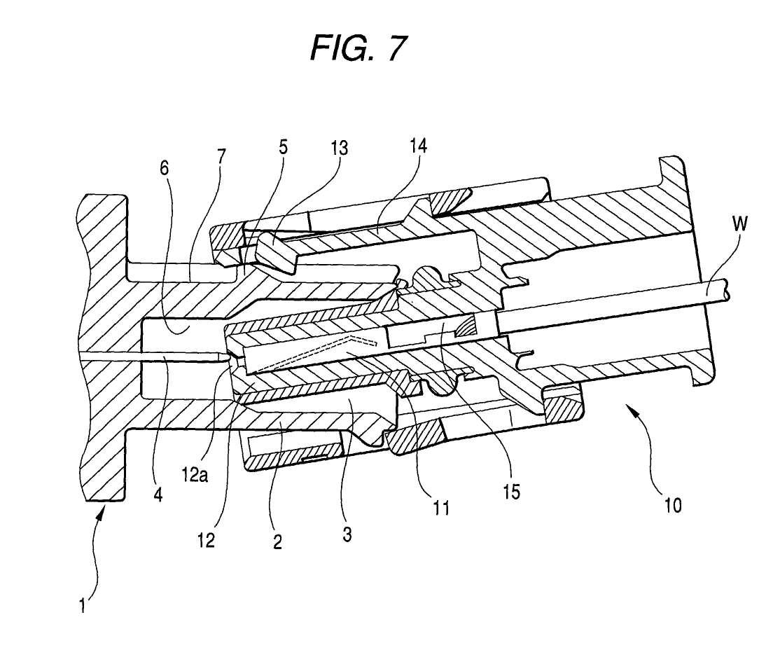

One preferred embodiment of a connector fitting structure of the present invention will now be described with reference to FIGS. 1 to 4. FIG. 1 is a perspective view showing a male connector housing of the connector fitting structure of the invention, FIG. 2 is a vertical cross-sectional view of the male connector housing of FIG. 1, FIG. 3 is a vertical cross-sectional view, showing a condition in which a fitting portion of a female connector housing is inserted into such a position that its distal end is disposed at a front end of a narrowed portion of the male connector housing, and FIG. 4 is a vertical cross-sectional view showing a condition in which the fitting portion of the female connector housing is just to receive a male terminal.

As shown in FIGS. 1 and 2, the male connector housing 30 has a substantially tubular shape, and includes a tubular wall portion 31 of an integrally-molded construction, and a fitting chamber 32 for receiving the female connector housing 40 (described later) is defined by an inner peripheral surface of the wall portion 31. The male connector housing 30 has the male terminal 33 projecting into the fitting chamber 32, and an engagement groove 36 is formed on an outer surface of the wall portion 31 along the fitting direction. A retaining portion 34 for holding the male connector housing in a fitted condition to the female connector housing 30 is formed in the engagement groove 36. The narrowed portion 35 for regulating the direction of connection of a female terminal 41 to the male terminal 33 is formed at an inner end portion of the fitting chamber 32, and a length Y of this narrowed portion 35 in the fitting direction is larger than a length X of the projecting male terminal 33 (X<Y).

As shown in FIG. 3, the female connector housing 40 includes the fitting portion 42, provided at a center portion thereof, and a flexible lock arm 43 for engagement with the retaining portion 34 of the male connector housing 30 during the fitting operation. A terminal receiving chamber 44, in which the female terminal 41 is received, is formed within the fitting portion 42, and the fitting portion 42 has an insertion hole 42a formed in a front end thereof, and the male terminal 33 is inserted into the terminal receiving chamber through this insertion hole.

A fitting detection member 45 for detecting a half-fitted condition of the male and female connector housings 30 and 40 is fitted on the female connector housing 40, and substantially covers this female connector housing.

Next, the operation for fitting the male connector housing 30 and the female connector housing 40 together will be described. The flexible lock arm 43 of the female connector housing 40 is caused to slide along the engagement groove 36 in the male connector housing 30, thereby substantially properly regulating the fitting direction, and the fitting portion 42 of the female connector housing 40 is inserted into the fitting chamber 32 in the male connector housing 30.

Then, the front end of the fitting portion 42 reaches the front end of the narrowed portion 35, and thereafter the front end of the fitting portion 42 is brought into abutting engagement with the front end of the narrowed portion 35 or an inner surface near the front end of the narrowed portion 35 disposed near to the front end thereof, thereby regulating the fitting angle to the proper fitting direction. At this time, the fitting direction can be properly regulated before the front end of the fitting portion 42 reaches the distal end of the male terminal 33 so as to insert the male terminal 33 into the insertion hole 42a, since the length Y of the narrowed portion 35 in the fitting direction is larger than the length of the projecting male terminal 33 (X<Y). Therefore, the front end of the fitting portion 42 is prevented from impinging on the distal end of the male terminal 33.

After the fitting direction is properly regulated by the narrowed portion 35 as shown in FIG. 4, the female connector housing 40 is pushed in the fitting direction, and the distal end of the male terminal 33 is inserted into the insertion hole 42a, formed in the front end of the fitting portion 42, without impinging on the front end of the fitting portion 42.

When the female connector housing 40 is further pushed in the fitting direction, the flexible lock arm 14 slides over the retaining portion 34, and is engaged therewith, and the male terminal 33 is inserted into the terminal receiving chamber 44 in the female connector housing 40, and is electrically connected to the female terminal 41, so that the male and female connector housings 30 and 40 are completely fitted together. At the time of achieving the completely-fitted condition, the fitting detection member 45 is pushed to be moved in the fitting direction, and is retained in a properly-fitting detection position, so that the completely-fitted condition of the male and female connector housings 30 and 40 can be detected.

In the connector fitting structure of the above embodiment, the length Y of the narrowed portion 35 in the fitting direction is larger than the length X of the projecting male terminal 33 (X<Y). Therefore, before the front end of the fitting portion 42 reaches the distal end of the male terminal 30 so as to insert the male terminal 33 into the fitting portion 42, the fitting direction can be properly regulated by the front end of the narrowed portion 35, and the front end of the fitting portion 42 is prevented from impinging on the distal end of the male terminal 33 or other portion, and therefore the bending, breakage or the like of the male terminal 33 can be positively prevented.

As described above, in the connector fitting structure of the present invention, the second connector housing includes the narrowed portion of such a length that the narrowed portion extends beyond the distal end of the male terminal in the fitting direction, and during the fitting of the two connector housings to each other, the narrowed portion abuts against the front end of the first connector housing before the insertion of the male terminal into the first connector housing, thereby regulating the fitting angle of the first connector housing to the proper fitting direction.

Therefore, before the front end of the first connector housing reaches the distal end of the male terminal so as to insert the male terminal into the first connector housing, the fitting direction can be properly regulated by the front end of the narrowed portion, and the front end of the first connector housing is prevented from impinging on the distal end of the male terminal or other portion, and therefore the bending, breakage or the like of the male terminal can be positively prevented.

What is claimed is:

1. A connector fitting structure comprising:
a first connector housing including a female terminal received in a terminal receiving chamber;
a second connector housing including a male terminal projecting into a fitting chamber; and
a narrowed portion provided in said second connector housing, having such a length that said narrowed portion extends beyond a distal end of said male terminal in a fitting direction;
wherein said narrowed portion abuts against a front end of said first connector housing before said male terminal is fittingly inserted into said first connector housing, so that a fitting angle of said first connector housing is regulated to a proper fitting direction, and
said female terminal and said male terminal are connected together when said first connector housing is fitted to the second connector housing.
